(19) United States
(12) Patent Application Publication
(10) Pub. No.: US 2005/0125949 A1
(43) Pub. Date: Jun. 16, 2005

(54) Adjustable hinge for assembling a non-frame plate glass of a bathroom

(75) Inventor: Chih Heng Lin, Changhua City (TW)

Correspondence Address: TROXELL LAW OFFICE PLLC, 5205 LEESBURG PIKE, SUITE 1404, FALLS CHURCH, VA, 22041, US

(73) Assignee: Fang Tsan Co., Ltd.

(21) Appl. No.: 10/731,468

(22) Filed: Dec. 10, 2003

(51) Int. Cl. E05D 7/04

(52) U.S. Cl. 16/248

(57) ABSTRACT

An adjustable hinge for assembling a non-frame plate glass of a bathroom includes a clamp base for Clamping a non-frame plate glass, an elastic press unit received in the clamp base and a bottom base pivotally fitted in the clamp base. The bottom base is fixed with a fixing rod fitted thereon with a position-recovering rotary button, having its outer surface bored with an engage groove and screwed with at least one tightening bolt. The engage groove is timely engaged and held by the press wheel of the elastic press unit, and the tightening bolt is screwed inward to fix the position-recovering rotary button on the fixing rod. Thus, the position-recovering rotary button can be adjusted to any preset position and the non-frame plate glass can be adjusted to swing to any position fully and accurately closed with a doorjamb.

### BACKGROUND OF THE INVENTION

1. Field of the Invention

This invention relates to a hinge particularly to one able to be adjusted to control a non-frame plate glass of a bathroom to recover its position and enabling the non-frame plate glass to swing to be fully and accurately closed with a doorjamb of a bathroom and also having an esthetic appearance.

2. Description of the Prior Art

Nowadays, people are particular about the layout, the equipment and the display of articles of a bathroom, and more and more people like to partition a bathroom into an inner space for shower bath and an outer space, which can always be kept dry and clean. Generally, a high-class bathroom is partitioned with a non-frame plate glass pivotally assembled on a doorjamb of the bathroom by hinges, or directly assembled pivotally on a wall surface by hinges to let the non-frame plate glass swing open and closed freely.

In some cases, a bathroom is not built in a square shape due to poor building quality or a non-square building locality; therefore after two doorjambs a are fixed on the wall surface of a bathroom and a non-frame plate glass is assembled on one doorjamb or directly assembled on a wall surface by hinges, it is impossible to make the non-frame plate glass closed fully and accurately with the doorjamb or with the wall surface. The reason is that a conventional bathroom hinge can only be swung vertically for 90 degrees; therefore when the non-frame plate glass is assembled on a non-parallel doorjamb or wall surface, it cannot accurately be closed fully with another doorjamb and consequently a gap may form therebetween, not only spoiling its esthetic appearance but also rendering shower water splashing outward.

### SUMMARY OF THE INVENTION

The objective of the invention is to offer an adjustable hinge for assembling the non-frame plate glass of a bathroom. The hinge has a bottom base pivotally fitted thereon with a position-recovering rotary button having an engage groove in the outer surface. The engage groove of the position-recovering rotary button is timely engaged and held by the press wheel of an elastic press unit, which is positioned in the lower groove of a clamp base. The position-recovering rotary button is provided with a tightening bolt, which can be screwed or unscrewed to adjust the position-recovering rotary button to any preset position to enable the non-frame plate glass to swing to be fully and accurately closed with the doorjamb of a bathroom, preventing shower water from splashing outward and having an esthetic appearance.

### BRIEF DESCRIPTION OF DRAWINGS

This invention will be better understood by referring to the accompanying drawings, wherein:

FIG. 1 is a perspective view of an adjustable hinge for assembling the non-frame plate glass of a bathroom in the present invention:

FIG. 2 is an exploded perspective view of the adjustable hinge for assembling the non-frame plate glass of a bathroom in the present invention:

FIG. 3 is, a cross-sectional view of the adjustable hinge for assembling the non-frame plate glass of a bathroom in the present invention:

FIG. 4 is a side c ross-sectional view of the adjustable hinge assembled thereon with a non-frame plate glass in the present invention:

FIG. 5 is a side cross-sectional view of the adjustable hinge for assembling a non-frame plate glass in the present invention, showing a tightening bolt unscrewed for adjustment:

FIG. 6 is a side cross-sectional view of the adjustable hinge for assembling a non-frame plate glass in the present invention, showing the non-frame plate glass turned and the tightening bolt screwed tight after the bearing of the hinge is adjusted: and

FIG. 7 is a side cross-sectional view of the adjustable hinge for assembling a non-frame plate glass in the present invention, showing the non-frame plate glass fully closed with a doorjamb.

### DETAILED DESCRIPTION OF THE PREFERRED EMBODIMENT

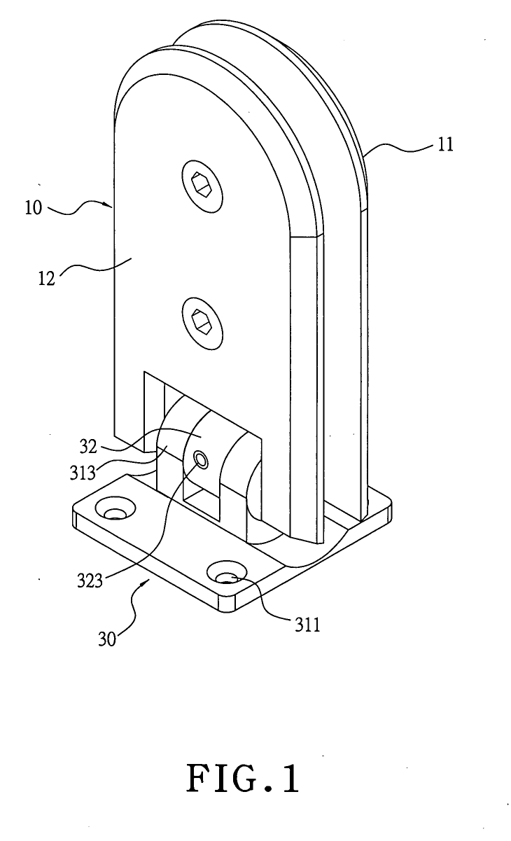

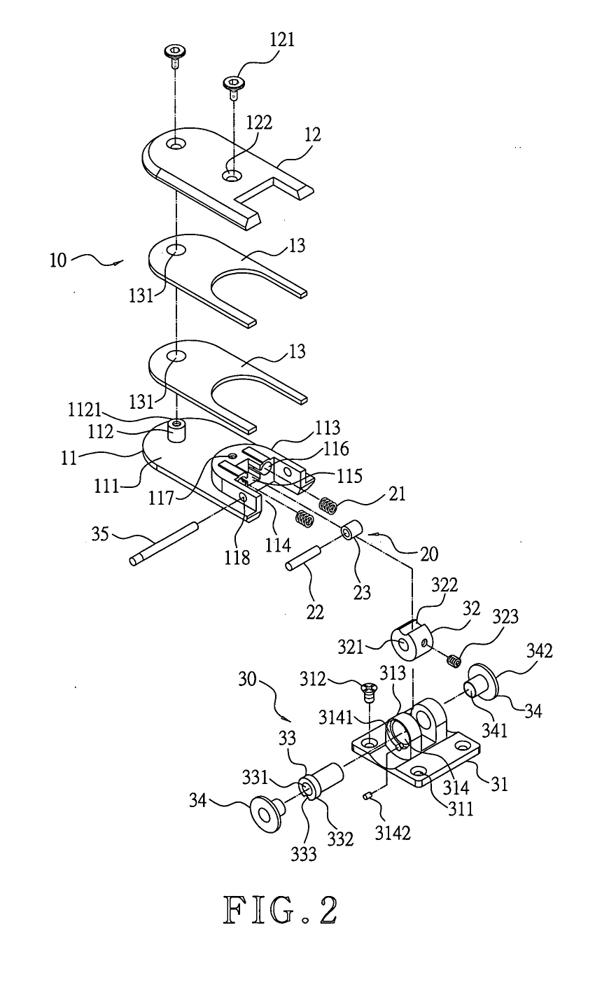

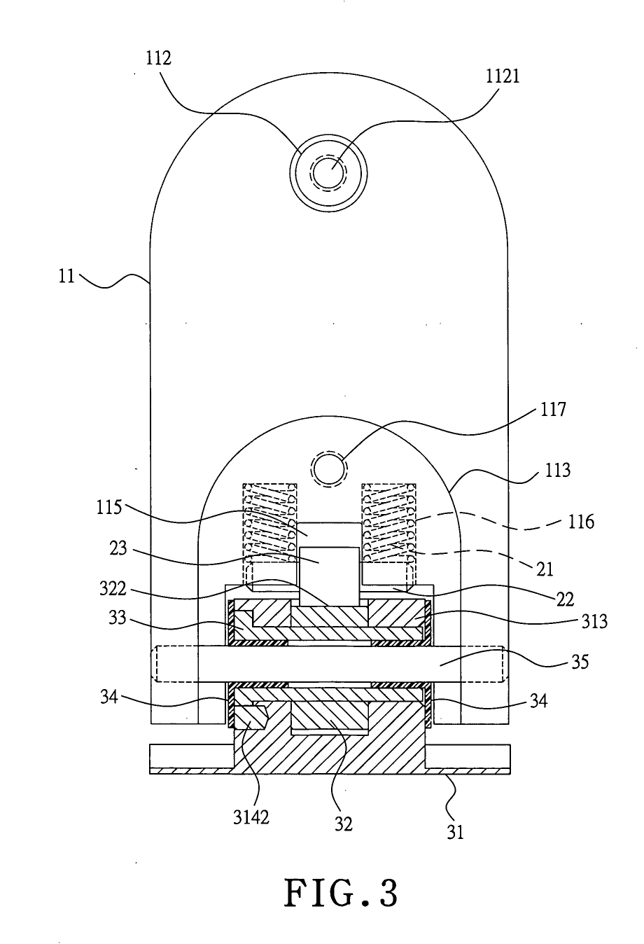

A preferred embodiment of an adjustable hinge for assembling a non-frame plate glass of a bathroom in the present invention, as shown in FIGS. 1, 2 and 3, includes a clamp base, 10, an elastic press unit 20 and a bottom base 30 as main components combined together.

The clamp base 10 consists of a main clamp plate 11, an auxiliary clamp plate 12 and two cushion sheets 13 positioned between the main and the auxiliary clamp plate 11, 12. The main plate 11 contains a base plate 111, a threaded stud 112 protruding upward near the upper edge of the base plate 111 and having a threaded hole 1121, and a projecting portion 113 formed at the lower end of the base plate 111 and flush with the threaded stud 112. The base plate 111 and the projecting portion 113 have their lower central portion bored with an accommodating groove 114, and the projecting portion 113 is bored in the center with a press-wheel receiving groove 115 communicating with the accommodating groove 114. Further, the projecting portion 113 has its lower opposite inner sides respectively bored with a lengthwise spring receiving groove 116 communicating with the press-wheel receiving groove 115, its topside bored with a threaded hole 117 and its lower opposite outer sides respectively bored with a pin hole 118. The auxiliary clamp plate 12 having the same shape as the main clamp plate 11 is provided with two through holes 122 respectively matching with the threaded stud 112 and the threaded hole 117 of the main clamp plate 11 for two bolts 121 to be respectively screwed therein. The two cushion sheets 13 are respectively bored in the left end with a positioning hole 131 for the threaded stud 112 of the main clamp plate 11 to be fitted therein, letting the two cushion sheets 13 fitted between the inner side wall of the base plate 111 of the main clamp plate 11 and the inner wall of the auxiliary clamp plate 12 and also hold the opposite outer walls of a non-frame plate glass 40 inserted and positioned by the threaded stud 112 of the main clamp plate 11.

The elastic press unit 20 consists of two springs 21, an interacting shaft 22 and a press wheel 23. The two springs 21 are respectively received in the two spring receiving grooves 116 at the opposite inner sides of the projecting portion 113 of the main clamp plate 11. The interacting shaft 22 is transversely inserted through the press-wheel receiving groove 115 and has its opposite ends respectively positioned in the two spring receiving grooves 116 and pressed by the two springs 21. The press wheel 23 made of plastic is fitted around the intermediate section of the interacting shaft 22, able to produce an elastic resisting force.

The bottom base 30 contains a base body 31, a position-recovering rotary button 32, a fixing rod 33, two stuffing members 34 and an elongate pin 35.

The base body 31 has its four corners respectively bored with an insert hole 311 for a bolt 312 to be screwed therein to fix the base body 31 on a wall surface or on a doorjamb. The base body 31 is further provided on the topside with two symmetrical ears 313 respectively having a shaft hole 314, and one of the two ears 313 has the outer side of its shaft hole 314 formed with a stepped positioning groove 3141 having an engage block 3142 protruding inward at the outer side edge.

The position-recovering rotary button 32 to be received between the two ears 313 of the base body 31 is bored with a shaft hole 321 aligned to the two shaft holes 314 of the two ears 313 and an axial arc-shaped engage groove 322 at a preset location of the outer edge. The position-recovering rotary button 32 has its opposite sides respectively provided with a tightening bolt 323 able to be screwed in the shaft hole 321.

The fixing rod 33 made of copper is inserted in the two shaft holes 314 of the two ears 313 of the base body 31 and the shaft hole 321 of the position-recovering rotary button 32, having a shaft hole 331 and a head 332 with a comparatively large diameter. The head 332 of the fixing rod 33 is bored with an engage notch 333 at a preset location of its outer side edge. Thus, when the head 332 of the fixing rod 33 is fitted in the positioning groove 3141 of the ear 313 of the base body 31, the engage notch 333 of the fixing rod 33 can exactly engage with the engage block 3142 on the outer side edge of the positioning groove 3141 of the ear 313 to keep the fixing rod 33 immovable on the two ears 313 of the base body 31 The tightening bolt 323 of the position-recovering rotary button 32 can screw inward to tightly press the outer wall of the fixing rod 33 and retain the position-recovering rotary button 32 in position.

The two stuffing members 34 are respectively inserted in the two shaft holes 314 of the two ears 313 of the base body 31 and the opposite shaft holes 331 of the fixing rod 33. Each stuffing member 34 has a shaft hole 341 and a head 342 with a comparatively large diameter, with the two heads 342 of the two stuffing members 34 respectively sealing the opposite ends of the fixing rod 33.

The elongate pin 35 is inserted through the two pin holes 118 of the main clamp plate 11 and the two shaft holes 341 of the two stuffing members 34, letting the two ears 313 of the bottom base 30 pivotally positioned in the accommodating groove 114 of the main clamp plate 31 and able to rotate therein.

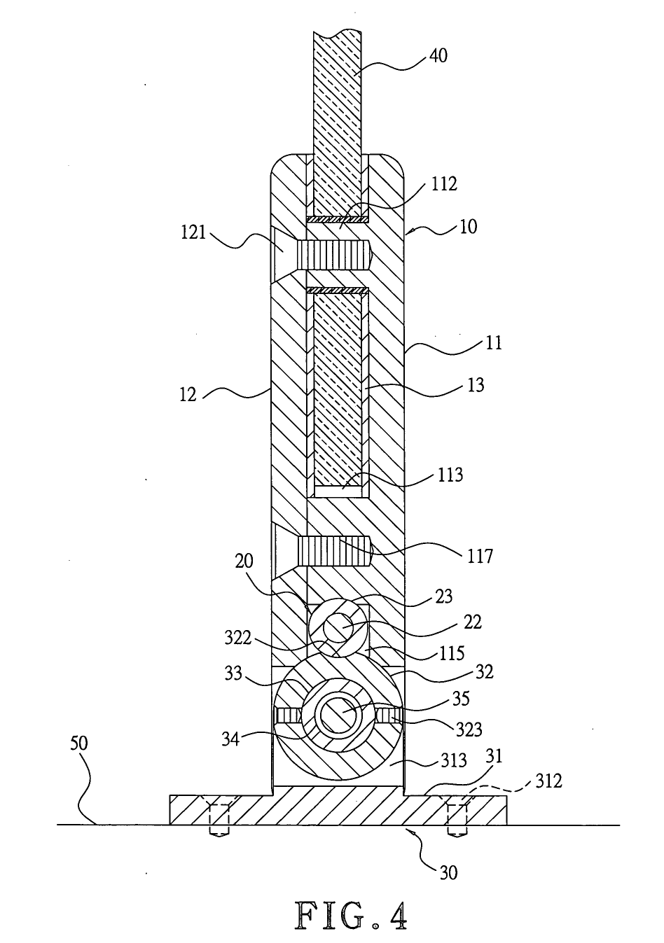

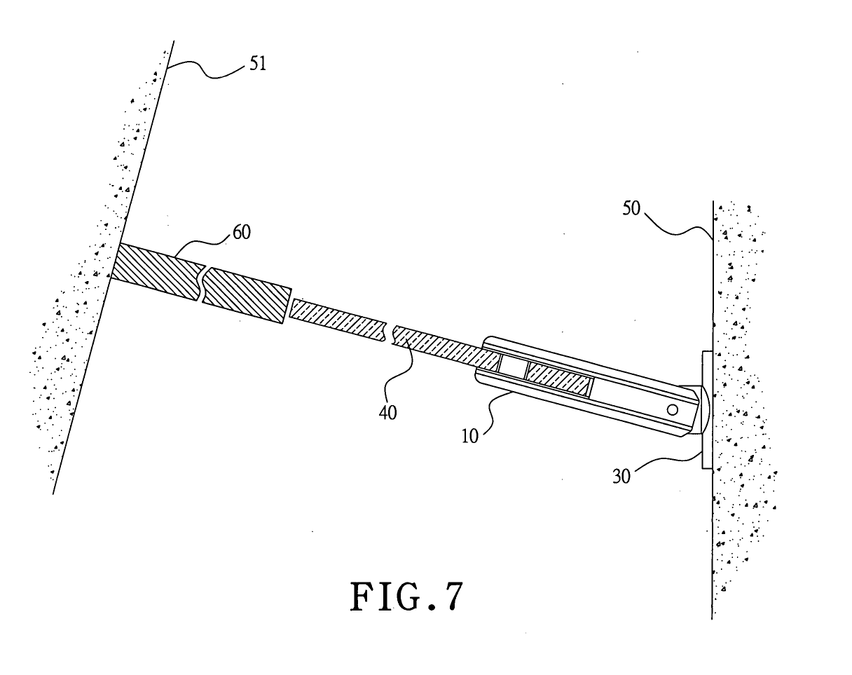

The hinge of the invention can be fixedly assembled on a wall surface or on a doorjamb of a bathroom for clamping a non-frame plate glass thereon to enable the non-frame plate glass to turn pivotally. The hinge of the invention can be adjusted in its position so it is applicable to non-parallel doorjambs or wall surfaces. If the hinge of the invention is to be assembled on a wall surface 50, as shown in FIGS. 4 and 7, the bottom base 30 of the hinge is first fixed on the wall surface 50 and a non-frame plate glass 40 is firmly clamped on the clamp base 10 to be swung open and closed with a doorjamb 60 assembled on another wall surface 51. Since the two corresponding wall surfaces 50, 51 are not parallel to each other; therefore the orientating angle of the hinge must be larger than 90 degrees so as to enable the non-frame plate glass 40 on the hinge to swing to be fully and accurately closed with the doorjamb 60.

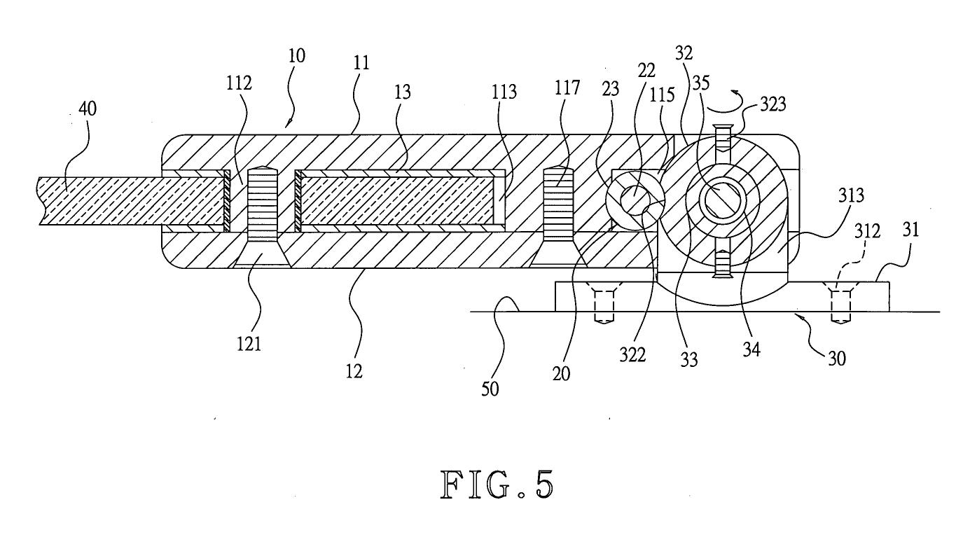

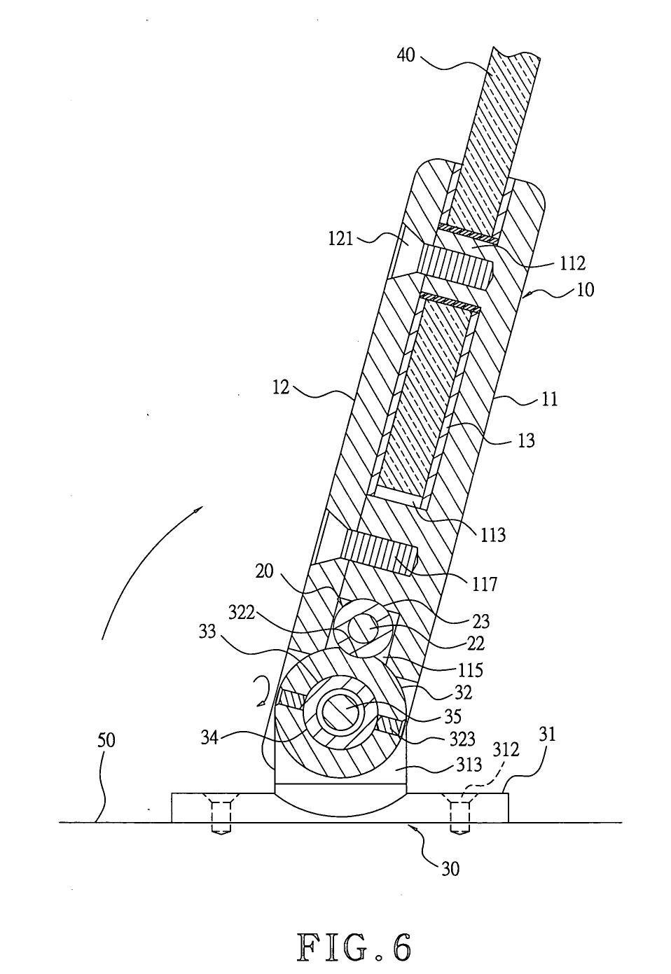

Before adjusting the orientating angle of the hinge, the press wheel 23 of the elastic press unit 20 is adjusted to engage in the engage groove 322 of the position-recovering rotary button 32 on the bottom base 30. Subsequently, the tightening bolt 323 of the position-recovering rotary button 32 is unscrewed to let the position-recovering rotary button 32 rotate together with the clamp base 10 and the elastic press unit 20, as shown in FIG. 5. At this time, the non-frame plate glass 40 is swung to a position where the non-frame plate glass 40 can be fully closed with the doorjamb 60 and then the tightening bolt 323 on the position-recovering rotary button 32 is screwed tight, letting the engage groove 322 of the position-recovering rotary butt on 32 exactly aligned to the doorjamb 60, as shown in FIG. 6. By so designing, when the non-frame plate glass 40 is swung to a closed position with the doorjamb 60, the press wheel 23 of the elastic press unit 20 will engage in the engage groove 322 of the position-recovering rotary button 32, accurately positioning the non-frame plate glass 40.

To sum up, the hinge of the invention can always make the non-frame plate glass 40 fully and accurately closed with the doorjamb 60, impossible to let shower water splash outward. In, addition, the hinge of the invention can be adjusted to any positions a user prefers, easy and convenient in adjustment.

While the preferred embodiment of the invention has been described above, it will be recognized and understood that various modifications may be made therein and the appended claims are intended to cover all such modifications that may fall within the spirit and scope of the invention.

1. An adjustable hinge for assembling a non-frame plate glass of a bathroom comprising a clamp base, an elastic press unit and a bottom base:
Said clamp base having a main clamp plate and an auxiliary clamp plate combined together correspondingly, said main clamp plate and said auxiliary clamp plate clamping a non-frame plate glass therebetween, said main clamp plate formed with a projecting portion on the inner lower side, said projecting portion having its lower end bored with an accommodating groove, said accommodating groove receiving said elastic press unit therein:
Said elastic press unit having an elastic press wheel pushing against said bottom base pivotally positioned at the lower end of said main clamp plate, said bottom base able to be fixedly assembled on a doorjamb or a wall surface, said non-frame plate glass able to swing together with said clamp base and said bottom base, said non-frame plate glass able to be fully closed with said doorjamb:
Said bottom base formed with a base body having two symmetrical ears extending upward on the upper side, a position-recovering rotary button received between said two ears, said position-recovering rotary button having an engage groove bored in the outer edge and at least one tightening bolt screwed in one of the opposite sides, a fixing rod fixed with said two ears and inserted through and positioning said position-recovering rotary button, said fixing rod having its opposite ends respectively inserted and sealed by a stuffing member, an elongate pin inserted through said two stuffing members to pivotally position said base body in said accommodating groove of said main clamp plate, said press wheel of said elastic press unit engaged in said engage groove of said position-recovering rotary button to keep said clamp base in position, said tightening bolt screwed inward to closely push against said fixing rod inside said position-recovering rotary button to control the position of said engage groove of said position-recovering rotary button: and
Said tightening bolt of said position-recovering rotary button on said bottom base unscrewed to let said press wheel of said elastic press unit engaging in said engage groove of said position-recovering rotary button, said position-recovering rotary button actuated to rotate to a preset position by said elastic press unit on said clamp base, then said tightening bolt screwed in said position-recovering rotary button again, said non-frame plate glass able to be freely and accurately adjusted to swing to any closed position so long as said press wheel on said clamp base is rotated together with said non-frame plate glass and elastically engaged in said engage groove of said position-recovering rotary button, which is orientated in advance.

2. The adjustable hinge for assembling a non-frame plate glass of a bathroom as claimed in claim 1, wherein said projecting portion of said main clamp plate has its central lower end bored with, a press wheel receiving groove communicating with said accommodating groove, having its lower opposite inner sides respectively bored with a lengthwise spring receiving groove communicating with said press wheel receiving groove, said elastic press unit having two springs respectively received in said spring receiving groove and an interacting shaft having it central section fitted with said press wheel, said interacting shaft transversely received in said two spring receiving grooves and said press wheel receiving groove, said press wheel pushed downward together with said interacting shaft which has its opposite ends respectively compressed by said two springs.

3. The adjustable hinge for assembling a non-frame plate glass of a bathroom as claimed in claim 1, wherein said two ears of said base body are respectively bored with a shaft hole, and one said ear has the outer side edge of said shaft hole formed with a stepped positioning groove for fitting the head of said fixing rod therein after said fixing rod is inserted through said shaft holes of said ears, said positioning groove having an engage block protruding inward at a preset location of its outer side edge, said fixing rod bored with an engage notch in the outer surface of its head, said engage block of said positioning groove engaged in said engage groove of said fixing rod to retain said fixing rod immovable.

4. The adjustable hinge for assembling a non-frame plate glass of a bathroom as claimed in claim 1, wherein said fixing rod is made of copper.

5. The adjustable hinge for assembling a non-frame plate glass of a bathroom as claimed in claim 1, wherein said position-recovering rotary button has its outer opposite edges respectively screwed with a tightening bolt.
